(19) United States
(12) Patent Application Publication
(10) Pub. No.: US 2002/0179427 A1
(43) Pub. Date: Dec. 5, 2002

(54) Process for purifying titanium tetrachloride

(76) Inventors: John Burnham Goddard, Grand Island, NY (US); Michael Mark Litwin, Cheektowaga, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 09/861,949

(22) Filed: May 21, 2001

(51) Int. Cl. B01D 3/14; B01D 3/34; C01G 23/02

(52) U.S. Cl. 203/29; 203/49; 203/71; 423/69; 423/265; 423/492

(57) ABSTRACT

A process of purifying titanium tetrachloride by first refluxing titanium tetrachloride (TiCl₄) with copper powder, rendering the impurities of vanadium, niobium and antimony nonvolatile, and then in a single step fractionally distilling the refluxed mixture to effectively and substantially reduce any arsenic, tin, niobium and vanadium in the titanium tetrachloride.

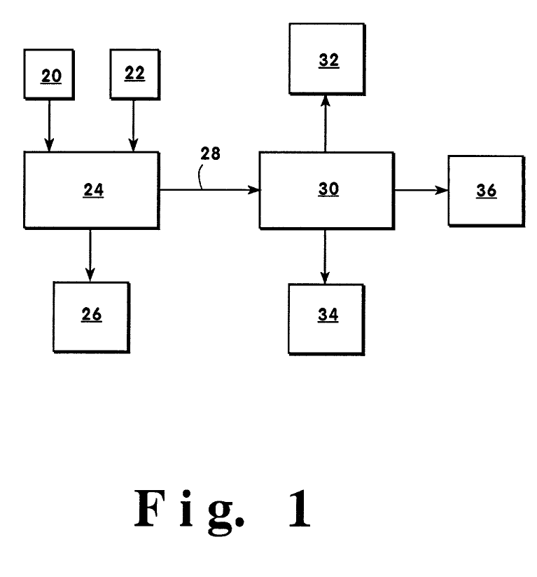

### FIELD OF THE INVENTION

This invention relates to a process for purifying a chemical compound. More specifically, this invention relates to a process of purifying titanium tetrachloride by refluxing titanium tetrachloride (TiCl₄) with copper powder.

### BACKGROUND OF THE INVENTION

Titanium tetrachloride is generally produced commercially by chlorinating titanium ores. Unfortunately, the produced titanium tetrachloride contains a variety of contaminants or impurities such as niobium, tin, vanadium, arsenic, antimony and the like.

Titanium tetrachloride is presently used in the semiconductor industry as a chemical vapor deposition precursor for titanium silicide and titanium nitride layers. Titanium tetrachloride is an article of commerce and millions of pounds are made each year for the paint industry, for which titanium tetrachloride is converted to titanium dioxide, a white pigment. Titanium tetrachloride is also a precursor for the production of titanium metal by the Kroll (magnesium reduction) process. It is also used in Ziegler-Natta catalysts. These applications do not require the purity demanded by the electronics industry.

Thus, typically the metallic impurities in titanium tetrachloride intended for semiconductor production should preferably be below 100 ppb (parts per billion) by weight. Distillation of the titanium tetrachloride (b.p. 136° C.) effectively removes the nonvolatile impurities, i.e. those with chlorides with atmospheric boiling points much greater or much less than 136° C. Other impurities with closer boiling points are more problematic. These include vanadium (VCl₄ b.p. 152° C., VOCl₃ b.p. 126° C.), arsenic (AsCl₃ b.p. 130° C.) antimony (SbCl₅ b.p. 172° C., extrapolated; SbCl₃ b.p. 223° C.), tin (SnCl₄ b.p. 114° C.), niobium (NbCl₅ b.p. 254° C.). These impurities, particularly arsenic and antimony, can be detrimental at the parts-per-billion (ppb) levels to the semiconductor device. Titanium tetrachloride is typically purified by distillation, but this does not effectively remove close-boiling metal chloride impurities to ppb levels. Vanadium at ppm levels or greater has typically been removed from crude titanium tetrachloride by reaction with copper.

U.S. Pat. No. 2,530,735 discloses the removal of vanadium by refluxing titanium tetrachloride over copper packing, e.g. raschig rings. The vanadium was reduced from 2800 ppm to 0.3 ppm by this process. U.S. Pat. No. 2,915,364 discloses that vanadium can be removed from titanium tetrachloride by distilling over copper turnings. British patent No. 1,301,790 teaches the addition of benzenesulfonic acid dichloramide followed by copper, then distillation. Vanadium was reduced to 50-70 ppb, arsenic and phosphorus were reduced to 3-10 ppb each. Adding organic materials is undesirable from a product purity standpoint, since they or their decomposition products may distill over into the product.

In the prior art, adding small amounts of water to titanium tetrachloride has been used to remove niobium and tantalum. For example, U.S. Pat. No. 2,600,081 discloses that water will selectively react with aluminum chloride, rendering it nonvolatile during distillation. However, water interfered with vanadium removal by copper, so a second distillation was required for vanadium removal. U.S. Pat. No. 4,070,252 discloses the addition of water to remove niobium and tantalum pentachlorides by rendering them nonvolatile during the subsequent titanium tetrachloride distillation.

Accordingly, it is an object of the present invention to provide a one step distillation process for purifying titanium tetrachloride comprising the refluxing of titanium tetrachloride with a copper powder to react the copper powder with the titanium tetrachloride to render the impurities vanadium, niobium and antimony nonvolatile and then a single step of fractionally distilling the refluxed mixture to reduce impurities such as arsenic, antimony, and tin.

It is another object of the present invention to provide a process of purifying titanium tetrachloride to an extent that arsenic is reduced to less than 100 ppb by weight, tin to less than 100 ppb by weight, niobium to less than 100 ppb by weight, antimony to less than 100 ppb by weight and vanadium to less than 100 ppb by weight (parts per billion by weight of titanium tetrachloride).

It is yet another object of the present invention to convert inexpensive commercial grade of titanium tetrachloride to a high purity grade that would be suitable for the electronics industry for making products such as semiconductors.

### SUMMARY OF THE INVENTION

This invention relates to a process for the purification of titanium tetrachloride (TiCl₄) containing at least three of the impurities selected from the group comprising arsenic (As), antimony (Sb), niobium (Nb), tin (Sn) and vanadium (V), comprising the steps:

(a) refluxing titanium tetrachloride with copper powder (Cu) for a period of time and at an elevated temperature sufficient for rendering vanadium, niobium and antimony nonvolatile; and then

(b) fractionally distilling in a single step the refluxed mixture of step (a) to reduce the impurity of arsenic to less than 100 ppb by weight, preferably less than 50 ppb by weight; antimony to less than 100 ppb by weight, preferably less than 50 ppb by weight; niobium less than 100 ppb by weight, preferably less than 50 ppb by weight; tin less than 100 ppb by weight, preferably less than 75 ppb by weight; vanadium less than 100 ppb by weight, preferably less than 30 ppb by weight; and Cu less than 100 ppb by weight, preferably less than 50 ppb by weight, thus producing a 99.99% pure titanium tetrachloride, metals basis and preferably 99.999% pure titanium tetrachloride.

Preferably, the copper powder could be sized between about 400 and about 35 mesh (Tyler mesh), more preferably between about 325 and about 65 mesh, and most preferably about −100 mesh. A preferred embodiment of the invention is to digest or reflux titanium tetrachloride with copper powder in a vessel for a period of time between about 10 minutes and about 240 minutes, preferably between about 20 minutes and about 120 minutes at most preferably about 30 minutes and at a temperature between about 75° C. and about 150° C., preferably between about 100° C. and about 140° C. and most preferably about 136° C. which is the boiling point of the titanium tetrachloride. At 136° C., refluxing assumes the material is boiling and condensing without significant distillation of volatiles (mainly titanium tetrachloride). The copper particle size should be relatively small, as discussed above. The finer the size of the copper, the greater the surface area per unit weight of material, and the faster the purification reaction. During this time, the copper reacts with some of the titanium tetrachloride to produce a lavender material that renders some impurities nonvolatile. It is believed that the lavender material is probably CuCl—TiCl₃ or in any case involves the reduction of some of the titanium tetrachloride to a trivalent titanium chloride compound. The amount of copper used is preferably about 0.1 to 5% of the weight of the titanium tetrachloride and preferably between about 1% to 2% of the weight of the titanium tetrachloride. More than 2% may be wasteful and without much benefit, and less than 1% may decrease the reaction rate with the impurities and lead to more impurity carryover once the distillation has begun.

### BRIEF DESCRIPTION OF THE DRAWING

The sole drawing is a schematic of a purification process of the subject invention.

### DETAILED DESCRIPTION

The subject invention involves a process of reducing impurities by combining the refluxing of titanium tetrachloride with copper powder with a single step of distilling the refluxed mixture.

The reaction with copper powder removes antimony as well as niobium and vanadium without the undesirable step of adding water. The process introduces no volatile impurities such as organic materials, unlike British Patent No. 1,301,790 where an organic material was employed. The only chemical additive to the vessel is copper powder that preferably is in a chemically pure state (preferably >99.9%, metals basis). Copper chlorides are relatively nonvolatile. Thus copper is generally not detected in the distillate fractions. The subject invention accomplishes the purification in one distillation. Since the purification is one fractional distillation step, it is simpler and hence less costly than a process requiring two distillations. The subject invention removes effectively both antimony and arsenic by combining copper powder refluxing with fractional distillation. Both arsenic and antimony impurities are present in crude titanium tetrachloride and since both are potential N-type dopants for semiconductors, their presence is considered detrimental even at ppb levels. Refluxing over copper powder also removes niobium. Since niobium chloride (NbCl₅) is volatile (b.p. 254° C.), niobium removal from titanium tetrachloride is desirable. The technique of the subject invention is simple in that it incorporates a reaction or “gettering” step with a single step of fractional distillation. In summary, the invention involves digesting or refluxing of crude titanium tetrachloride material over copper powder, then in a single step fractionally distilling and rejecting the earlier fractions to eliminate arsenic.

The sole drawing shows a flow diagram of the process for purification of titanium tetrachloride as discussed above. In this embodiment, impure titanium chloride 22 and copper 20 are introduced into digester 24 (for refluxing). This enables the partial removable of non-volatile elements 26 including antimony, niobium and vanadium. Treated titanium chloride mixture 28 then undergoes separation in fractional distillation 30. The distillation process separates titanium chloride mixture 28 into lights impurities 32 including argon (Ar) and tin (Sn), and bottoms impurities 34 including copper, antimony, niobium and antimony. Titanium tetrachloride is recovered as pure product 36.

### EXAMPLE

A previously distilled titanium tetrachloride product (430 g) containing 148 ppb antimony, 340 ppb niobium, 20 ppb vanadium, 449 ppb tin, and 200 ppb arsenic was refluxed for 30 minutes with 4.94 g copper power −100 mesh at one atmosphere under nitrogen and 136° C., then fractionally distilled in a 21 mm bore spinning band quartz column under nitrogen at atmospheric pressure until 409 g titanium tetrachloride had been collected. The reflux ratio was 3, the number of theoretical plates about 30. None of the distillate fractions had detectable antimony (<20 ppb) or niobium (<9 ppb). The vanadium was reduced to 6 ppb. Tin and arsenic concentrated in the first fraction of the distillate. In the final 50-60% of the distillate, tin and arsenic were not detected (<63 ppb Sn, <40 ppb As). No copper carryover from the pot was detected (all fractions were <20 ppb Cu).

The Table below summarizes the above results, in ppb weight basis.

| | TiCl₄ Feed to Still | TiCl₄ Product |
|---|---|---|
| Impurity | ppb by weight | ppb by weight |
| Antimony | 148 | <20 |
| Arsenic | 200 | <40 |
| Copper | 1000-2000 | <20 |
| Niobium | 340 | <9 |
| Tin | 449 | <63 |
| Vanadium | 20 | <6 |

Other metals with volatile chlorides may be removed by the copper distillation procedure. Since vanadium is effectively removed and niobium is also removed, it is expected that tantalum (in the same chemical group) would be removed if present. Tantalum chloride (TaCl₅) has an atmospheric boiling point of 242° C. The copper had little or no effect on removing arsenic or tin. Arsenic and tin could be removed by fractionation. Since AsCl₃ and SnCl₄ are more volatile than titanium tetrachloride, they are concentrated in the early fractions of distilled product. Bismuth could be removed by the copper, as it is in the same group as antimony, and its chloride has a higher boiling point than antimony (BiCl₃ b.p. 447° C.).

The copper could possibly be reused or recycled since most of the copper is likely unreacted. Copper of high purity is desirable, such as 99.999% pure copper. To remove metallic elements to below 100 ppb, preferably below 10 ppb, a high purity copper is preferred so that the purity of the distilled product is maintained.

The distillation may be carried out at subatmospheric or superatmospehric conditions, which will affect the boiling point of titanium tetrachloride. It is preferred to inert the reflux-distillation system with nitrogen, argon or helium gas, or almost any other non-reactive gas. If the system is initially evacuated and is air tight, no inerting gas need be used with the refluxing and the distillation steps.

This invention is not limited to the embodiment discussed and it will be appreciated that it is intended to cover all modification within the scope of the appended claims.

What is claimed:

1. A process for the purification of titanium tetrachloride containing at least three of the impurities selected from the group comprising arsenic, antimony, niobium, tin and vanadium, said process comprising the steps:
a) refluxing titanium tetrachloride with copper powder at a temperature sufficient to form a refluxed mixture in which vanadium, niobium and antimony in the titanium tetrachloride are not volatile; and
b) fractionally distilling the refluxed mixture to reduce arsenic to less than 100 ppb by weight; antimony to less than 100 ppb by weight; niobium less than 100 ppb by weight; tin less than 100 ppb by weight; vanadium less than 100 ppb by weight; and copper less than 100 ppb by weight.

2. The process of claim 1 wherein said arsenic is reduced to less than about 50 ppb by weight; said antimony is reduced to less than about 50 ppb by weight; said niobium is reduced to less than about 50 ppb by weight; said tin is reduced to less than about 75 ppb by weight; said vanadium is reduced to less than about 30 ppb by weight; and said copper is reduced to less than about 50 ppb by weight.

3. The process of claim 1 wherein the copper powder is sized between about 400 and about 35 Tyler mesh.

4. The process of claim 1 wherein the refluxing in is carried out at a temperature between about 75° C. and about 150° C.

5. The process of claim 4 wherein the refluxing is carried out for a period of time between about 10 minutes and about 240 minutes.

6. The process of claim 5 wherein the refluxing is carried out for a period of time between about 20 minutes and about 120 minutes.

7. The process of claim 6 wherein the refluxing is carried out at a temperature of about 136° C.

8. The process of claim 5 wherein the copper powder is between about 325 and about 65 Tyler mesh in size.

9. The process of claim 1 wherein the refluxing step is inerted by the addition of an inerting gas.

10. The process of claim 1 wherein the distillation step is inerted by the addition of a gas.

11. The process of claim 9 wherein the distillation step is inerted by the addition of an inerting gas.

12. The process of claim 11 wherein said arsenic is reduced to less than about 50 ppb by weight; said antimony is reduced to less than about 50 ppb by weight; said niobium is reduced to less than about 50 ppb by weight; said tin is reduced to less than about 75 ppb by weight; said vanadium is reduced to less than about 30 ppb by weight; and said copper is reduced to less than about 50 ppb by weight.

13. The process of claim 12 wherein the copper powder is sized between about 400 and about 35 Tyler mesh.

14. The process of claim 13 wherein the refluxing is carried out at a temperature between about 75° C. and about 150° C.

15. The process of claim 14 wherein the refluxing is carried out for a period of time between about 10 minutes and about 240 minutes.

16. The process of claim 15 wherein the refluxing in step a) is carried out for a period of time between about 20 minutes and about 120 minutes.

17. The process of claim 16 wherein the refluxing in step a) is carried out at a temperature of about 136° C.

18. The process of claim 17 wherein the copper powder is between about 325 and about 65 Tyler mesh in size.

19. The process of claim 18 wherein arsenic is reduced to less than about 40 ppb by weight and tin is reduced to less than about 63 ppb by weight.

20. The process of claim 18 wherein said arsenic is reduced to less than about 40 ppb by weight; said antimony is reduced to less than about 20 ppb by weight; said niobium is reduced to less than about 9 ppb by weight; said tin is reduced to less than about 63 ppb by weight; said vanadium is reduced to less than about 6 ppb by weight; and said copper is reduced to less than about 20 ppb by weight.
